(19) United States
(12) Patent Application Publication
(10) Pub. No.: US 2022/0098468 A1
(43) Pub. Date: Mar. 31, 2022

(54) USE OF ESTERAMINE TO INHIBIT THE AGGLOMERATION OF GAS HYDRATES

(71) Applicant: Arkema France, Colombes (FR)

(72) Inventors: Henry Delroisse, Pierre-Benite Cedex (FR); Gilles BARRETO, Pierre-Benite Cedex (FR)

(73) Assignee: Arkema France, Colombes (FR)

(21) Appl. No.: 17/428,472

(22) PCT Filed: Jan. 24, 2020
(86) PCT No.: PCT/FR2020/050111

§ 371 Date: Aug. 4, 2021

(30) Foreign Application Priority Data
Feb. 6, 2019 (FR) 1901152

(51) Int. Cl. C09K 8/524; C09K 8/035

(52) U.S. Cl. CPC C09K 8/524; C09K 2208/22; C09K 8/035

(57) ABSTRACT

A process is described for inhibiting and/or delaying and/or preventing the agglomeration of gas hydrates, comprising adding one or more compounds of formula (1) or salts thereof:

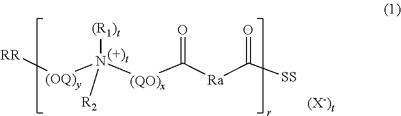

wherein RR, OQ, Ra, R₁, R₂, SS, X⁻, t, x and y are defined in the specification and for the use of said compounds for formula (1) for inhibiting and/or delaying and/or preventing the agglomeration of gas hydrates.

### CROSS-REFERENCE TO RELATED APPLICATIONS

This application is the national phase of International Application No. PCT/FR2020/050111, filed 24 Jan. 2020, which claims priority to French Application No. FR 1901152, filed 6 Feb. 2019. the disclosure of each of these applications being incorporated herein by reference in its entirety for all purposes.

### FIELD OF THE INVENTION

The present invention relates to the field of the extraction of hydrocarbons and more particularly to the field of the additives used to facilitate the extraction and the transportation of said hydrocarbons.

More specifically, the present invention relates to the use of a compound and also a process for limiting, or even preventing, the agglomeration and/or the formation of gas hydrates which are commonly known to disrupt the flow of hydrocarbons in the pipes for the extraction and transportation of said hydrocarbons.

### BACKGROUND OF THE INVENTION

The extraction of hydrocarbons, mainly oil, gas, condensates and others, is today carried out in very diverse environments and in particular in offshore sites, underwater sites or else in sites experiencing cold weather periods. These diverse environments can often result in significant cooling of the extracted fluids in contact with the cold walls of the transportation pipes.

Extracted fluids (or produced fluids or production fluids) is understood to mean the fluids comprising oil, gases, condensates, water and mixtures thereof. Oil is understood to mean, within the meaning of the present invention, crude oil, that is to say unrefined oil, originating from a deposit.

Gases is understood to mean, within the meaning of the present invention, crude natural gases, that is to say untreated gases, extracted directly from a deposit, such as, for example, hydrocarbons, such as methane, ethane, propane or butane, hydrogen sulfide, carbon dioxide and other compounds which are gaseous under the extraction conditions, and also the mixtures thereof. The composition of the extracted natural gas varies considerably depending on the wells. Thus, the gas can comprise gaseous hydrocarbons, water and other gases.

Condensates is understood to mean, within the meaning of the present invention, hydrocarbons of intermediate density. Condensates generally comprise mixtures of hydrocarbons which are liquid under the extraction conditions.

It is known that these production fluids generally comprise an aqueous phase, in a greater or lesser amount. The origin of this aqueous phase may be endogenous and/or exogenous to the underground reservoir containing the hydrocarbons, the exogenous aqueous phase generally originating from injection of water, also known as “injection water”.

The depletion of the sites discovered in the past is often nowadays leading the oil and gas industry to extract, in particular on new sites, from increasingly great depths, on offshore sites and with ever more extreme weather conditions.

On offshore sites in particular, the pipes for the transportation of the produced fluids are often positioned on the seabed, at ever greater depths, where the temperature of the seawater is often less than 15° C., more often less than 10° C., indeed even close to or equal to 4° C.

Similarly, it is common to find extraction sites located in geographical regions where the air and/or the surface water can be at relatively cold temperatures, typically below 15° C., indeed even below 10° C. In point of fact, at such temperatures, the produced fluids undergo significant cooling during their transportation. This cooling can be further magnified in the case of a shutdown or a slowdown in production, in which cases the contact time between the produced fluids and the cold walls of the pipe can increase, often considerably.

One of the disadvantages directly related to a more or less sudden lowering of the temperatures of the produced fluids is the formation of clathrates, also known as hydrate crystals, gas hydrates or more simply hydrates. The risk of formation of such hydrates in production fluids and in particular during oil, gas and condensate extraction is proportionately greater the lower the temperature of the production fluids and the higher the pressure of these fluids.

These clathrates are solid crystals (similar to those of water in the ice form) formed by water molecules, also called “hosts”, around one or more gas molecules, also called “guests”, such as methane, ethane, propane, butane, carbon dioxide or hydrogen sulfide.

The formation and the growth of these crystals are generally induced by a lowering of the temperature of the production fluids which exit hot from the geological reservoirs which contain them and which enter a cold region. These crystals can grow more or less rapidly and agglomerate and can cause pluggings or blockages of the production pipes, of the pipes for transportation of the hydrocarbons (oil, condensates, gas), of the gates, valves and other elements liable to be completely or at least partially blocked.

These pluggings/blockages can lead to losses in production of oil, condensates and/or gas, resulting in not insignificant, indeed even very substantial, economic losses. This is because these pluggings and/or blockages will have the consequence of a decrease in the production output, indeed even a shutdown of the production unit. In the event of a blockage, the search for the region of the blockage and its removal will have the consequence of a loss of time and of profit for this unit. These pluggings and/or blockages can also lead to malfunctions with regard to safety elements (for example safety valves).

These problems of formation and/or agglomeration of hydrates may also be encountered in many other situations, such as for example within injected fluids such as water, drilling mud or completion fluids, during a pressure maintenance operation, a drilling operation or a completion operation.

In order to reduce, delay or inhibit the formation and/or agglomeration of hydrates, an additive may be added to the production fluid. This additive, known as a “thermodynamic hydrate inhibitor” (THI) is generally an alcohol or alcohol derivative, for example methanol, or glycol, in the produced fluids containing the water/guest gas(es) mixture. It is nowadays commonly recognized that the addition of such an additive makes it possible to shift the equilibrium temperature for formation of the hydrates. In order to obtain an acceptable effectiveness, approximately 30% by weight of alcohol, with respect to the amount of water, is generally introduced. However, the toxicity of the alcohols or alcohol derivatives and the large amount of additive used are increasingly leading industrialists to adopt a new approach.

Another solution consists in adding an additive at low dosage, known as low dosage hydrate inhibitor (LDHI), to the produced fluids comprising the water/guest gas(es) mixture. This additive is also known as hydrate inhibitor and is introduced at a low dosage, generally of between 1% and 4% by weight, with respect to the weight of the water, it being understood that greater or smaller amounts are, of course, possible. Two types of hydrate-inhibiting additives are currently known: anti-agglomerants and kinetic hydrate inhibitors.

Anti-agglomerants are not inhibitors of the formation of hydrate crystals, they are surface agents that have the property of dispersing the crystals by being absorbed on them, which consequently prevents said hydrate crystals from agglomerating together. The adsorption of the anti-agglomerants on the crystals renders the latter lipophilic, which makes it possible to easily disperse them in the hydrocarbon liquid phase. The hydrate crystals, thus dispersed, can no longer plug the pipelines for transportation of the oil and gas production fluids, thus increasing the production, in particular the extraction of oil and gas.

Given the exploitation medium (oceans, seas), it is increasingly common for anti-agglomerants also to have to have low ecotoxicity, satisfactory biodegradability and low bioaccumulation. According to the recommendations of CEFAS (Centre for Environment, Fisheries and Aquaculture Science) in accordance with the OSPAR (Oslo-Paris Commission), in order for an additive to be green, i.e. environmentally compatible, it needs to meet two of the following three conditions:

1) Have an ecotoxicity (LC50 (lethal effects) and EC50 (toxic effects)) of greater than 10 mg·L⁻¹;

2) Have a biodegradability (OECD 306) in a marine environment of greater than 60%; and

3) Have a bioaccumulation (Log Pow) (OECD 117) of less than or equal to 3 or its molar mass greater than 700 g·mol⁻¹.

Other countries also impose two of these three conditions for additives used in petroleum and gas production, for instance corrosion inhibitors, kinetic hydrate inhibitors, anti-agglomerants, mineral deposit inhibitors, demulsifiers, deoilers, defoaming additives, paraffin inhibitors and dispersants, asphaltene inhibitors and dispersants, and hydrogen sulfide scavengers.

Anti-agglomerants are effective when a liquid hydrocarbon phase is present in contact with an aqueous phase circulating in the pipelines for transportation of the oil and gas production fluids. Generally, the water fraction should be less than 50%. Otherwise, the hydrate dispersion becomes too viscous to be able to be transported.

For the production of hydrocarbons with a high gas/oil ratio, the low concentration of condensate and the high concentration of water in the produced hydrocarbon makes it very difficult to use anti-agglomerants to inhibit the agglomeration of gas hydrates.

To enable the use of anti-agglomerant additives for gas fields, fields with high water fractions and with low proportions of condensates, a method for inhibiting the agglomeration of gas hydrates has been developed. It consists in adding to the field to be treated a refined hydrocarbon or a recycled and conditioned produced hydrocarbon, with an anti-agglomerant or a dispersant to increase the condensate fraction and thus decrease the water fraction. Such a method is described for example in U.S. Pat. Nos. 5,816,280, 5,877,361 and 9,988,568.

Document U.S. Pat. No. 9,988,568 discloses a mixture of a refined hydrocarbon and an anti-agglomerant. However, an instability of the mixture is observed, the anti-agglomerant being sparingly miscible/soluble in the refined hydrocarbon or in the produced hydrocarbon.

Consequently there is a real need to develop compositions that make it possible to inhibit and/or delay and/or prevent the agglomeration of gas hydrates which do not have the drawbacks of the hydrate-inhibiting compositions known from the prior art, and advantageously which are more effective than the hydrate-inhibiting compositions known from the prior art.

The applicant has now surprisingly discovered that the use of (poly)esteramines of a particular structure makes it possible to meet the objectives defined above in their entirety or at the very least in part.

In the text hereinbelow, unless otherwise indicated, the limits of a range of values are included in that range, especially in the expressions “between” and “ranging from . . . to . . . ”.

Other subjects, features, aspects and advantages of the invention will become even more clearly apparent on reading the description and examples which follow.

### SUMMARY OF THE INVENTION

The first subject of the present invention is therefore the use, for inhibiting and/or delaying and/or preventing the agglomeration of gas hydrates, of one or more compounds of formula (1), and also the salts thereof:

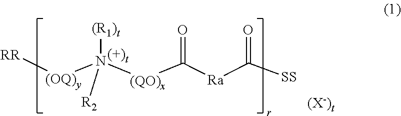

in which:
RR represents —C(═O)-G′,
SS is chosen from G″ and —(OQ)-G″,
QO represents an alkyleneoxy group containing from 2 to 4 carbon atoms, preferably 2 or 3 carbon atoms, more preferably 2 carbon atoms, knowing that all the QO groups present in the compound of formula (1) may be identical or different,
Ra is chosen from the group consisting of a direct bond, a cycloalkylene, cycloalkenylene or arylene group and a saturated or unsaturated, linear or branched C₁-C₂₀ hydrocarbon chain optionally substituted by one or more —OH groups, preferably an alkylene radical of formula —(CH₂)_{z}—, in which z is an integer from 1 to 20, preferably from 1 to 10, preferably from 2 to 6, and most preferably 4, a substituted alkylene radical, said alkylene radical being substituted by 1 or 2 —OH groups, an alkenylene radical having from 1 to 20, preferably 1 to 10 carbon atoms,
R₁ is chosen from a C₁-C₆ hydrocarbon radical, preferably from a C₁-C₄ alkyl radical, the phenyl radical and a phenylalkyl radical, such as benzyl,
R₂ is chosen from an R⁷ radical or an R¹⁰-(G)ᵤ- radical,
R⁷ is chosen from a hydrocarbon radical having 1 to 7, preferably 1 to 6 carbon atoms, more preferably 1 to 4 carbon atoms, an aryl or arylalkyl group (for example, a phenyl or naphthyl group), a radical of formula H—(OQ)ᵥ- (in which QO is as defined previously and v represents an integer between 1 and 20, preferably between 1 and 10, more preferably between 1 and 6, and more preferably still between 1 and 4, limits included), HO(CH₂)_{q}—, and a group of formula (2):

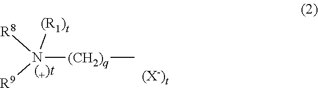

in which
R⁸ and R⁹, which are identical or different, are chosen from a hydrocarbon radical comprising from 1 to 6 carbon atoms, preferably from 1 to 4 carbon atoms, limits included, or else R⁸ and R⁹, together with the nitrogen atom to which they are bonded, form a cycle with 5, 6 or 7 vertices, optionally comprising one or more heteroatoms chosen from oxygen, nitrogen and sulfur,
R¹⁰ is chosen from a hydrocarbon radical comprising from 1 to 24 carbon atoms, preferably from 6 to 24 carbon atoms, better still from 8 to 24 carbon atoms, more preferably from 10 to 24 carbon atoms, more preferably from 12 to 24 carbon atoms, limits included, and a radical of formula R⁴—O-(QO)_{w}-T-, in which QO is as defined above, R⁴ is chosen from hydrogen and a hydrocarbon radical comprising from 1 to 24 carbon atoms, preferably from 6 to 24 carbon atoms, better still from 8 to 24 carbon atoms, more preferably from 10 to 24 carbon atoms, more preferably from 12 to 24 carbon atoms, limits included, where w represents an integer in the range of from 0 to 20, preferably from 0 to 10, more preferably from 0 to 6, and more preferably still from 0 to 4, limits included, and T represents an alkylene group comprising from 1 to 6 carbon atoms, limits included, preferably from 1 to 4 carbon atoms, most preferably 2 or 3 carbon atoms,
G represents a group of formula (3):

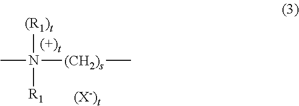

X⁻ is chosen from halides, sulfates, carbonates,
G′ is chosen from a saturated or unsaturated, linear or branched, hydrocarbon radical comprising from 6 to 30 carbon atoms, and an —Ra—C(═O)—SS radical, Ra and SS being as defined above,
G″ is chosen from the —OH radical, an —OR radical, an —N^{(+)t}R₃R₄(R₁)ₜ radical, an —NH—C(═O)—R radical and an —NH—C(═O)—OR radical, R₁ and R₄ being as defined previously and where R₃ is chosen from a linear or branched hydrocarbon radical, preferably a linear or branched alkyl radical, comprising from 1 to 24 carbon atoms, preferably from 1 to 20, more preferably from 1 to 14 carbon atoms, limits included, an HO(CH₂)_{q}— radical, and an H(OQ)- radical, a —(C═O)-G′ radical and a —(OQ)ₓ-(C═O)-G′ radical,
R is a linear or branched hydrocarbon radical, preferably a linear or branched alkyl radical, comprising from 1 to 24 carbon atoms, preferably from 6 to 24 carbon atoms, better still from 8 to 24 carbon atoms, more preferably from 10 to 24 carbon atoms, more preferably from 12 to 24 carbon atoms, limits included,
j represents an integer between 1 and 20, preferably between 1 and 10, more preferably between 1 and 6, and more preferably still between 1 and 4, limits included,
q is an integer from 1 to 10, preferably from 2 to 6, limits included, and most preferably q is 2 or 3,
r represents an integer in the range from 1 to 15, preferably from 1 to 10, more preferably from 1 to 5, limits included, more preferably 1, 2, 3 or 4,
s represents an integer between 1 and 5, limits included, preferably 1, 2 or 3, more preferably 2 or 3,
t is chosen from 0 and 1,
u is an integer from 0 to 5, preferably from 0 to 3, more preferably u is 0 or 1, more preferably still u is 0,
x represents an integer between 1 and 20, preferably between 1 and 10, more preferably between 1 and 6, and more preferably still between 1 and 4, limits included,
y represents an integer between 1 and 20, preferably between 1 and 10, more preferably between 1 and 6, and more preferably still between 1 and 4, limits included,
   it being understood that if more than one variable of the same denomination is present in the compound of formula (1), these can be identical or different, independently of one another.

The compounds of formula (1) for which Ra represents a direct bond are not preferred.

According to a preferred embodiment of the present invention, the compounds of formula (1) are those for which:
G′ is chosen from an —Ra—C(═O)—OH radical, an —Ra—C(═O)—OR radical, and an —Ra—C(═O)—SS radical,
Ra represents an alkylene radical of formula —(CH₂)_{z}—, in which z is an integer from 1 to 20, preferably from 1 to 10, preferably from 2 to 6, and most preferably z is equal to 4,
t is equal to 0,
u is equal to 0,
j represents an integer between 1 and 6, and more preferably still between 1 and 4, limits included,
x represents an integer between 1 and 6, and more preferably still between 1 and 4, limits included,
y represents an integer between 1 and 6, and more preferably still between 1 and 4, limits included,
   it being understood that if more than one variable of the same denomination is present in the compound of formula (1), these can be identical or different, independently of one another,
   the other variables being as defined previously.

According to yet another preferred embodiment, the compounds of formula (1) are those for which:
RR represents —C—(═O)-G′,
SS represents —(OQ)-G″, where G″ is an —N^{(+)t}R₃R₄(R₁)ₜ radical,
G′ is chosen from a saturated or unsaturated, linear or branched, hydrocarbon radical comprising from 6 to 30 carbon atoms,
R₃ is an —(OQ)ₓ-C(═O)-G′ radical,
OQ represents an alkyleneoxy group containing 2 or 3 carbon atoms,
Ra is an alkylene radical of formula —(CH₂)_{z}—, in which z is an integer from 1 to 10, preferably from 2 to 6, and most preferably z is equal to 4,
R₂ is an HO—(CH₂)_{q}— radical, q is an integer from 2 to 6, limits included, and most preferably q is 2 or 3,
R₁ is chosen from a C₁-C₆ hydrocarbon radical, preferably from a C₁-C₄ alkyl radical,
j represents an integer between 1 and 20, preferably between 1 and 10, more preferably between 1 and 6, and more preferably still between 1 and 4, limits included,
t is chosen from 0 or 1,
x represents an integer between 1 and 20, preferably between 1 and 10, more preferably between 1 and 6, and more preferably still between 1 and 4, limits included,
y represents an integer between 1 and 20, preferably between 1 and 10, more preferably between 1 and 6, and more preferably still between 1 and 4, limits included,
   it being understood that if more than one variable of the same denomination is present in the compound of formula (1), these can be identical or different, independently of one another,
   the other variables being as defined previously.

According to yet another preferred embodiment, the compounds of formula (1) are those for which:
RR represents —C—(═O)-G′ where G′ is an —Ra—C(═O)—SS radical,
Ra is an alkylene radical of formula —(CH₂)_{z}—, in which z is an integer from 1 to 10, preferably from 2 to 6, and most preferably 4,
SS represents —(OQ)-G″ with G″ being chosen from an —NH—C(═O)—R radical and an —NH—C(═O)—OR radical,
R is a linear or branched hydrocarbon radical, preferably a linear or branched alkyl radical, comprising from 8 to 24 carbon atoms, preferably from 10 to 24 carbon atoms, more preferably from 12 to 24 carbon atoms, limits included,
j represents an integer between 1 and 20, preferably between 1 and 10, more preferably between 1 and 6, and more preferably still between 1 and 4, limits included,
t is chosen from 0 or 1,
x represents an integer between 1 and 20, preferably between 1 and 10, more preferably between 1 and 6, and more preferably still between 1 and 4, limits included,
y represents an integer between 1 and 20, preferably between 1 and 10, more preferably between 1 and 6, and more preferably still between 1 and 4, limits included,
it being understood that if more than one variable of the same denomination is present in the compound of formula (1), these can be identical or different, independently of one another,
   the other variables being as defined previously.

The counterions of these salts may be, for example and in a nonlimiting manner, alkali metal (for example sodium or potassium) ions, alkaline-earth metal (for example calcium or magnesium) ions, ammoniums, phosphoniums, halides (for example chloride, bromide or iodide), sulfate, hydrogen sulfate, mesylate, carboxylates, hydrogen carbonates, carbonates, phosphonates or phosphates.

The compounds of formula (1) that can be used in the context of the present invention are known and can be easily synthesized from procedures known to a person skilled in the art, available in the scientific literature, patent literature or else on the Internet. Some of the compounds of formula (1) are for example described in US20100078364 A1 and in US20140144814 A1.

In the use according to the present invention, the compound of formula (1) is generally present in an amount ranging preferably from 0.1% to 10% by weight, more preferentially from 0.3% to 8% by weight and better still from 0.4% to 4% by weight, relative to the total weight of the aqueous phase in a production fluid.

The content of aqueous phase may be easily measured on a sample of the production fluid after decantation, according to the techniques known to a person skilled in the art.

Preferably, the use according to the present invention limits, or even prevents, the formation and/or agglomeration of gas hydrates during the production of hydrocarbons, or during a drilling operation or during a completion operation.

More preferentially, the use according to the present invention limits, or even prevents, the formation and/or the agglomeration of gas hydrates in a process for extracting oil, condensates or gas, during the drilling, the completion operation or during the production.

Another subject of the present invention is a process for limiting or even preventing the formation and/or agglomeration of gas hydrates, comprising a step of adding one or more compounds of formula (1), as defined previously, to a production fluid comprising an aqueous phase and one or more gases.

The limitation or the reduction, or even the prevention or the blocking of the formation of hydrates may be evaluated by the test described in the examples below.

According to one embodiment of the invention, the compound of formula (1) can be used in a “carrier liquid”, in particular when it is desirable or necessary to increase the concentration of condensate and thus decrease the concentration of water. Thus, and according to one embodiment, the use of the present invention employs at least one compound of formula (1) in a carrier liquid.

A carrier liquid is a non-aqueous liquid phase in which one or more anti-agglomerants can be dissolved at least in part and/or dispersed. It may be chosen, for example, without limitation, from refined or unrefined liquid hydrocarbons, and generally those described in documents U.S. Pat. Nos. 5,816,280, 5,877,361 and 9,988,568, alcohols, and others.

According to one preferred embodiment, the carrier liquid has a low water miscibility, and preferably has a water miscibility of less than 500 g·L⁻¹, preferably less than 250 g·L⁻¹, more preferably less than 150 g·L⁻¹, advantageously less than 50 g·L⁻¹, better still less than 10 g·L⁻¹. A carrier liquid having a miscibility of greater than 500 g·L⁻¹ may of course be envisaged, but in this case the amount of carrier liquid miscible in the production water will be greater and it will then be recommended or even necessary to make additions of composition comprising the anti-agglomerant agent.

### DETAILED DESCRIPTION OF THE INVENTION

Within the meaning of the present invention, the miscibility is measured at ambient temperature and at ambient pressure by measuring the concentration of the species in question in water when the two phases are in contact at equilibriumt, by means of various assay methods such as for example gravimetric analysis, titrimetry, spectrophotometry, chromatography.

According to another preferred embodiment of the present invention, the carrier liquid comprises at least one alcohol comprising one (1) or more hydroxyl groups on a linear, branched or cyclic, saturated or unsaturated hydrocarbon chain. The hydrocarbon chain generally contains from 1 to 30 carbon atoms, preferably from 3 to 26 carbon atoms, more preferably from 5 to 22 carbon atoms, more preferably from 6 to 12 carbon atoms. The hydroxyl group(s) may be in the terminal position(s) and/or on all the other carbons of the hydrocarbon chain, that is to say that the hydroxyl functions may be, independently of one another, other primary, secondary or tertiary hydroxyl functions.

According to a preferred embodiment, the carrier liquid comprises at least one alcohol chosen from alcohols comprising from 1 to 3 hydroxyl functions and from 6 to 12 carbon atoms. According to another preferred embodiment, the carrier liquid comprises at least one alcohol of empirical formula C₈H₁₈O.

According to a very particularly preferred embodiment, the carrier liquid comprises at least one alcohol chosen from octan-1-ol, octan-2-ol, octan-3-ol, octan-4-ol, 2-methylheptan-1-ol, 2-methylheptan-4-ol, 5-methylheptan-1-ol, 5-methylheptan-2-ol, 4-methylheptan-2-ol, 4-methylheptan-4-ol, 2-methylheptan-4-ol, 2-ethylhexan-1-ol, 4-ethylhexan-1-ol, 3-ethylhexan-2-ol, 3-ethylhexan-3-ol, 4-ethylhexan-2-ol, 2-ethyl-2-methylpentan-1-ol, 2-ethyl-3-methylpentan-1-ol, 2-ethyl-4-methylpentan-1-ol, 2-ethyl-3-methylpentan-1-ol, 3-ethyl-2-methylpentan-1-ol, 3-ethyl-2-methylpentan-2-ol, 3-ethyl-4-methylpentan-2-ol, 3-ethyl-2-methylpentan-3-ol, 2-propylpentan-1-ol, 2,2-dimethylhexan-1-ol, 2,4-dimethylhexan-2-ol, 2,5-dimethylhexan-1-ol, 3,4-dimethylhexan-2-ol, 3,5-dimethylhexan-2-ol, 4,4-dimethylhexan-2-ol, 4,5-dimethylhexan-2-ol, 4,5-dimethylhexan-3-ol, 5,5-dimethylhexan-1-ol, 5,5-dimethylhexan-3-ol, 6-methylheptan-2-ol, 2-methylheptan-3-ol, 2,3-dimethylheptan-2-ol, 2,3-dimethylhexan-3-ol, 5,5-dimethylhexan-2-ol, 3-methylheptan-2-ol, 4-methylheptan-3-ol, 2,4-dimethylhexan-3-ol, 2,5-dimethylhexan-2-ol, 3,4-dimethylhexan-3-ol, 3,5-dimethylhexan-3-ol, 4-methylheptan-1-ol, 2-methylheptan-2-ol, 3-methylheptan-4-ol, 5-methylheptan-3-ol, 2,2-dimethylhexan-3-ol, 2,5-dimethylhexan-3-ol, 4-ethylhexan-3-ol, 2-ethyl-2,3-dimethylbutan-1-ol, 2,2,3-trimethylpentan-1-ol, 2,2,3-trimethylpentan-3-ol, 2,3,4-trimethylpentan-3-ol, 2,2,4-trimethylpentan-1-ol, 2,4,4-trimethylpentan-1-ol, 3,4,4-trimethylpentan-1-ol, and 3,4,4-trimethylpentan-2-ol.

More preferably, the carrier liquid comprises at least one alcohol chosen from octan-1-ol, octan-2-ol, octan-3-ol, octan-4-ol, 2-ethylhexan-1-ol, 4-ethylhexan-1-ol, 3-ethylhexan-2-ol, 3-ethylhexan-3-ol, 4-ethylhexan-2-ol, and 2-ethyl-2-methylpentan-1-ol, and very particularly preferably, the liquid carrier comprises at least one alcohol chosen from octan-1-ol, octan-2-ol and 2-ethylhexan-1-ol.

The carrier liquid may be added to the production fluid in a proportion to make it possible to obtain a water fraction of 90% or less, better still 85% or less, even better still 80% or less, even better still 75% or less, even better still 70% or less, even better still 65% or less, even better still 60% or less, even better still 55% or less, even better still 50% or less, even better still 45% or less, even better still 40% or less, even better still 35% or less, even better still 30% or less, even better still 25% or less, even better still 20% or less, expressed by volume of aqueous phase relative to the total volume of liquid. The carrier liquid is preferably added in a proportion that makes it possible to obtain a water fraction of 50% or less.

According to one embodiment, the carrier liquid should preferentially not interfere or react with the compound of formula (1) defined previously or with the other additives which may be used in the use according to the present invention, and in particular with the optional corrosion inhibitors, deposit inhibitors or other production chemical additives that can be used.

In addition to the presence of a carrier liquid during the use of the compound of formula (1) according to the present invention, it may also be advantageous to use jointly, separately or alternately, one or more other additives commonly used in oil and gas production, such as for example corrosion inhibitors, kinetic hydrate inhibitors, mineral deposit inhibitors, demulsifiers, deoilers, defoaming additives, paraffin inhibitors and dispersants, asphaltene inhibitors and dispersants, hydrogen sulfide scavengers, drag or friction reducers, aromas, dyes, preservatives, and others if necessary or if desired.

In a preferred embodiment, the use of the present invention may also include the use of one or more organic solvents. Preferably, the organic solvent(s) are chosen, without limitation, from C₁ to C₄ alcohols, glycols, glycol ethers, ketones and mixtures thereof, more preferentially from methanol, ethanol, isopropanol, n-butanol, isobutanol, ethylene glycol (or monoethylene glycol), 1,2-propylene glycol, 1,3-propylene glycol, hexylene glycol, butyl glycol, ethylene glycol dibutyl ether, methyl ethyl ketone, methyl isobutyl ketone, diisobutyl ketone, N-methylpyrrolidone, cyclohexanone, xylenes, toluene, and mixtures of several glycols, for example ethylene glycol, butyl glycol and others.

It is also possible, if it is desired or proves necessary, to use jointly, separately or alternately, other agents capable of inhibiting and/or delaying and/or preventing the agglomeration of gas hydrates, such as for example thermodynamic hydrate inhibitors and kinetic hydrate inhibitors. If mixtures of gas hydrate inhibitors are used, these mixtures may be added concomitantly and/or before and/or after the injection of the composition according to the present invention.

According to another aspect, the present invention relates to a process that makes it possible to limit, or even prevent, the agglomeration and/or the formation of gas hydrates by using at least one compound of formula (1) as described previously, optionally in combination with one or more other additives, fillers, solvents and other components well known to a person skilled in the art, and in particular in combination with a carrier liquid and/or an anti-agglomerant, as defined previously.

The process of the present invention comprises a step of bringing at least one anti-agglomerant compound of formula (1) as defined previously into contact with production water. When a sufficient amount of anti-agglomerant compound is used, the formation of a gas hydrate plug is inhibited. In the absence of such an amount, the formation of a gas hydrate plug is not inhibited.

The anti-agglomerant compound of formula (1) may be injected into the production field by being premixed with other additives, as defined above, for example a carrier liquid, and/or independently with one or more other additives. Alternatively, the carrier liquid can be injected into the production field by being premixed with the anti-agglomerant compound of formula (1) or else independently of said anti-agglomerant compound of formula (1).

The appropriate amount of anti-agglomerant compound of formula (1) necessary for inhibiting the formation of a hydrate plug is determined for each particular system as a function of the temperature, pressure, salt composition of the water, the proportion of water and oil and the composition of the gas. Thus, the anti-agglomerant compound is used in an amount ranging preferably from 0.05% to 15% by weight, more preferentially from 0.1% to 8% by weight and better still from 0.1% to 5% by weight, relative to the total weight of the aqueous phase in the production fluid.

The process of the present invention makes it possible to inhibit the formation of hydrates irrespective of the nature of the hydrocarbon or of the mixture of hydrocarbons. The process is particularly effective for light gases or gases with a low boiling point, such as hydrocarbon gases having 1 to 5 carbons and mixtures of these gases, under ambient conditions. Non-limiting examples of these gases are methane, ethane, propane, n-butane, iso-butane, iso-pentane and mixtures thereof. The hydrocarbons may also include, for example, other compounds which may, for example, be carbon dioxide (CO₂), hydrogen sulfide (H₂S), dinitrogen (N₂) and the other compounds commonly encountered during oil and gas production.

The compound of formula (1) may be introduced into the production fluid continuously, discontinuously, regularly or irregularly, or temporarily, in one or more portions. The anti-agglomerant compound of formula (1) is generally introduced upstream of the region at risk of the presence of hydrates, whether at the surface, at the well head or at the well bottom.

It may be useful or advantageous to also introduce, before, after and/or during the injection of the anti-agglomerant compound of formula (1), one or more injection additives, well known to a person skilled in the art, as indicated previously, and for example, and without limitation, those chosen from refined or unrefined hydrocarbons, such as petrol, diesel, gas oil, kerosene and others.

The invention will become more clearly apparent by means of the following examples, which are presented solely by way of illustration, without any intention of limiting the scope of the desired protection defined by the appended claims. Throughout the description, examples and claims, all the ranges of values should be understood as being “limits included” (that is to say that the limits are included in said ranges), unless otherwise specified.

In the examples that follow, all the amounts are indicated as weight percentages relative to the total weight of the composition, unless otherwise indicated.

### EXAMPLES

### Anti-Agglomeration Test of the Composition According to the Invention

The comparative composition (A) and the composition according to the invention (B) were prepared from the ingredients, the contents of which are indicated in Table 1 below:

TABLE 1

| | Composition A | Composition B |
|---|---|---|
| | (comparative) | (invention) |
| Noramium ® M2C (1) | 30 | — |
| Armohib CI-5150 (2) | — | 30 |
| Butyl glycol (solvent) | 70 | 70 |

(1) dicocodimethylammonium chloride, sold by Arkema
(2) methyl-quaternized N-methyl dialkanolamine/oleic acid diacid copolymer sold by Nouryon.

The effectiveness of the preceding Compositions A and B, as anti-agglomerant, was determined on a model fluid representing a production fluid comprising tetrahydrofuran (THF). THF hydrates form at atmospheric pressure and are regularly used for detecting the effectiveness of compounds that are candidates as gas hydrate anti-agglomerants.

The model fluid comprises:
30% by weight of aqueous phase consisting of a mixture of demineralized water and tetrahydrofuran (THF) in a 1:1 volume ratio, and
70% by weight of iso-octanol.

The thermodynamic equilibrium temperature for hydrate formation of this model fluid is 2° C. at atmospheric pressure. In other words, the THF hydrates form at temperatures of less than or equal to 2° C.

3 groups of 3 test cells each containing 18.7 mL of model fluid are provided. Group 1 represents the reference, added to group 2 is 1% by weight of Composition A, relative to the total weight of aqueous phase in each of the three cells, and added to group 3 is 1% by weight of Composition B, relative to the total weight of aqueous phase, in each of the three cells.

The anti-agglomerant effectiveness of the hydrate-inhibiting composition is measured at various subcoolings (−12° C. and −22° C.) for a dosage of 1% by weight of anti-agglomerant relative to the weight of the aqueous phase. The formation of hydrates depends mainly on the temperature and the pressure, and also on the composition of the guest gas(es). To be able to compare the performance of the additives, the notion of subcooling value is used. The subcooling (SC) value is thus defined as the difference between the temperature of the produced fluids (or exploitation temperature T) and the thermodynamic equilibrium temperature of formation of the hydrate crystals (Teq) for a given pressure and a given composition of the hydrate-forming gases and of the aqueous phase, according to the following equation: SC=T−Teq. When the subcooling value is less than or equal to 0° C., there is a risk of gas hydrate formation.

As indicated above, the subcooling value represents the temperature difference between the exploitation, or imposed, temperature and the thermodynamic equilibrium temperature for hydrate formation of the production fluid. In other words, for a subcooling value of −12° C., the imposed temperature must be −10° C. Similarly, for a subcooling value of −22° C., the temperature must be −20° C.

The experimental device, described especially by M. L. Zanota et al. (“Hydrate Plug Prevention by Quaternary Ammonium Salts”, Energy & Fuel, 19(2), (2005), 584-590), is composed of a motor which imposes an oscillating movement on a rack. The rack contains 12 borosilicate glass tubes having a diameter of 17 mm and a height of 60 mm.

Each tube is closed and contains the mixture described above and also a 316L stainless-steel ball 0.8 cm in diameter. The ball allows the mixture to be stirred, allows the agglomeration of the hydrate crystals to be observed visually and constitutes a crystallization initiator.

The rack is immersed in a thermostatic bath, comprising a water/ethylene glycol mixture (1/1), the temperature of which varies between −30° C. and +30° C. by means of a Huber variostat.

The various samples are subjected to cooling and heating cycles governed by the programmable variostat. The temperature descent rates are defined and programmed. The variostat is equipped with two temperature probes, an internal one and an external one, connected to a computer allowing the temperature to be monitored and recorded.

The tubes thus prepared are placed in a thermostatic bath at a temperature of +20° C. with stirring. The temperature is then lowered to −10° C. which corresponds to a subcooling of −12° C. At this temperature, the oscillation is maintained for 20 hours (the movement of the balls in the tubes is observed visually) before being stopped. After two hours of stoppage at −10° C., stirring is restarted, and the movement of the balls in the tubes is again observed.

The temperature is then lowered to −20° C. (again at a rate of −1° C. per minute), which corresponds to a subcooling of −22° C. At this temperature of −20° C., oscillation is maintained for 20 hours before being stopped. After two hours of stoppage at −20° C., stirring is restarted, and the movement of the balls in the tubes is observed visually.

The effectiveness of the composition is then evaluated visually by observing the movement of the balls in the tubes. If the balls circulate, the product tested is effective. Conversely, if the balls remain blocked, or if hydrate crystals are stuck to the wall of the tube, the product tested is not a good anti-agglomerant. The larger the number of blocked balls, the less effective the product. The results are presented in the Table 2 below:

TABLE 2

| | Number of balls blocked | | Number of balls blocked | |
|---|---|---|---|---|
| | after 20 hours of stirring | | after 2 hours of stoppage | |
| Subcooling | −12° C. | −22° C. | −12° C. | −22° C. |
| Reference without | 3/3 | 3/3 | 3/3 | 3/3 |
| anti-agglomerant | | | | |
| Anti-agglomerant A | 2/3 | 3/3 | 3/3 | 3/3 |
| Anti-agglomerant B | 1/3 | 1/3 | 1/3 | 1/3 |

The results above show that Composition B, comprising a compound of formula (1) according to the present invention, has good anti-agglomerant properties, of a higher level than composition A comprising a quaternary ammonium compound, quaternary ammoniums being known for their anti-agglomerant properties.

1. A process for limiting or preventing the formation and/or agglomeration of gas hydrates, comprising adding one or more compounds of formula (1) or salts thereof to a production fluid comprising an aqueous phase and one or more gases: 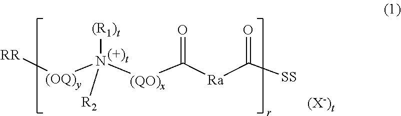
wherein:
RR represents —C(═O)-G′,
SS is chosen from G″ and —(OQ)-G″,
QO represents an alkyleneoxy group containing from 2 to 4 carbon atoms, where all the QO groups present in the compound of formula (1) may be identical or different,
Ra is chosen from the group consisting of a direct bond, a cycloalkylene, cycloalkenylene or arylene group and a saturated or unsaturated, linear or branched C₁-C₂₀ hydrocarbon chain optionally substituted by one or more —OH groups,
R₁ is chosen from a C₁-C₆ hydrocarbon radical,
R₂ is chosen from an R⁷ radical or an R¹⁰-(G)ᵤ- radical,
R⁷ is chosen from a hydrocarbon radical having 1 to 7 and a group of formula (2): 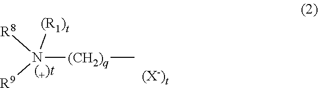
wherein
R⁸ and R⁹, which are identical or different, are chosen from a hydrocarbon radical comprising from 1 to 6 carbon atoms, limits included, or else R⁸ and R⁹, together with the nitrogen atom to which they are bonded, form a cycle with 5, 6 or 7 vertices, optionally comprising one or more heteroatoms chosen from oxygen, nitrogen and sulfur,
R¹⁰ is chosen from a hydrocarbon radical comprising from 1 to 24 carbon atoms, limits included, and a radical of formula R⁴—O-(QO)_{w}-T-, wherein QO is as defined above, R⁴ is chosen from hydrogen and a hydrocarbon radical comprising from 1 to 24 carbon atoms, limits included, where w represents an integer in the range of from 0 to 20, limits included, and T represents an alkylene group comprising from 1 to 6 carbon atoms, limits included,
G represents a group of formula (3): 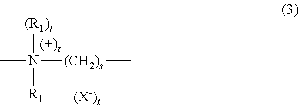
X⁻ is chosen from halides, sulfates, carbonates,
G′ is chosen from a saturated or unsaturated, linear or branched, hydrocarbon radical comprising from 6 to 30 carbon atoms, and an —Ra—C(═O)—SS radical, Ra and SS being as defined above,
G″ is chosen from the —OH radical, an —OR radical, an —N^{(+)t}R₃R₄(R₁)ₜ radical, an —NH—C(═O)—R radical and an —NH—C(═O)—OR radical, R₁ and R₄ being as defined previously and where R₃ is chosen from a linear or branched hydrocarbon radical comprising from 1 to 24 carbon atoms, limits included, an HO(CH₂)_{q}— radical, and an H(OQ)ⱼ- radical, a —(C═O)-G′ radical and a —(OQ)ₓ-(C═O)-G′ radical,
R is a linear or branched hydrocarbon radical, limits included,
j represents an integer between 1 and 20, limits included,
q is an integer from 1 to 10,
r represents an integer in the range from 1 to 15,
s represents an integer between 1 and 5, limits included,
t is chosen from 0 and 1,
u is an integer from 0 to 5,
x represents an integer between 1 and 20, limits included,
y represents an integer between 1 and 20, limits included, wherein if more than one of the same variable is present in the compound of formula (1), the variable can be identical or different, independently of one another.

2. The process according to claim 1, wherein for the compounds of formula (1):
G′ is chosen from an —Ra—C(═O)—OH radical, an —Ra—C(═O)—OR radical, and an —Ra—C(═O)—SS radical,
Ra represents an alkylene radical of formula —(CH₂)_{z}—, in which z is an integer from 1 to 20,
t is equal to 0,
u is equal to 0,
j represents an integer between 1 and 6, limits included,
x represents an integer between 1 and 6, limits included,
y represents an integer between 1 and 6, limits included,
wherein if more than one of the same variable is present in the compound of formula (1), the variable can be identical or different, independently of one another,
the other variables being as defined in claim 1.

3. The process according to claim 1, wherein for the compounds of formula (1):
RR represents —C—(═O)-G′,
SS represents —(OQ)-G″, where G″ is an —N^{(+)t}R₃R₄(R₁)ₜ radical,
G′ is chosen from a saturated or unsaturated, linear or branched, hydrocarbon radical comprising from 6 to 30 carbon atoms,
R₃ is an —(OQ)ₓ-C(═O)-G′ radical,
OQ represents an alkyleneoxy group containing 2 or 3 carbon atoms,
Ra is an alkylene radical of formula —(CH₂)_{z}—, in which z is an integer from 1 to 10,
R₂ is an HO—(CH₂)_{q}— radical, q is an integer from 2 to 6, limits included,
R₁ is chosen from a C₁-C₆ hydrocarbon radical,
j represents an integer between 1 and 20, limits included,
t is chosen from 0 or 1,
x represents an integer between 1 and 20, limits included,
y represents an integer between 1 and 20, limits included,
wherein if more than one of the same variable is present in the compound of formula (1), the variable can be identical or different, independently of one another,
the other variables being as defined in claim 1.

4. The process according to claim 1, wherein for the compounds of formula (1):
RR represents —C—(═O)-G′ where G′ is an —Ra—C(═O)—SS radical,
Ra is an alkylene radical of formula —(CH₂)_{z}—, in which z is an integer from 1 to 10,
SS represents —(OQ)-G″ with G″ being chosen from an —NH—C(═O)—R radical and an —NH—C(═O)—OR radical,
R is a linear or branched hydrocarbon radical, limits included,
j represents an integer between 1 and 20, limits included,
t is chosen from 0 or 1,
x represents an integer between 1 and 20, limits included,
y represents an integer between 1 and 20, limits included,
wherein if more than one of the same variable is present in the compound of formula (1), the variable can be identical or different, independently of one another,
the other variables being as defined in claim 1.

5. The process according to claim 1, wherein the compound of formula (1) is present in an amount ranging from 0.1% to 10% by weight, relative to the total weight of the aqueous phase in a production fluid.

6. The process according to a claim 1, employing at least one compound of formula (1) in a carrier liquid.

7. The process according to a claim 1, employing at least one compound of formula (1) in a carrier liquid with low water miscibility.

8. The process according to claim 1, employing at least one compound of formula (1) in a carrier liquid, said carrier liquid comprising at least one alcohol comprising one (1) or more hydroxyl groups on a linear, branched or cyclic, saturated or unsaturated hydrocarbon chain, said hydrocarbon chain generally comprising from 1 to 30 carbon atoms.

9. The process according to a claim 1, employing at least one compound of formula (1) in a carrier liquid added to the production fluid in a proportion to make it possible to obtain a water fraction of 90% or less, expressed by volume of aqueous phase relative to the total volume of liquid.

10. (canceled)

11. The process according to claim 1, comprising a step of adding one or more compounds of formula (1), as defined in, in combination with one or more other additives, fillers, solvents.

12. The process according to claim 1, comprising a step of adding one or more compounds of formula (1) in combination with one or more other additives chosen from corrosion inhibitors, kinetic hydrate inhibitors, mineral deposit inhibitors, demulsifiers, deoilers, defoaming additives, paraffin inhibitors and dispersants, asphaltene inhibitors and dispersants, hydrogen sulfide scavengers, drag or friction reducers, aromas, dyes, preservatives, and optionally others.
